(19) United States
(12) Patent Application Publication
(10) Pub. No.: US 2024/0404288 A1
(43) Pub. Date: Dec. 5, 2024

(54) UNMANNED AERIAL VEHICLES (UAV)-ASSISTED IDENTIFICATION OF PERSON IN DURESS

(71) Applicant: The ADT Security Corporation, Boca Raton, FL (US)

(72) Inventor: Trevor GREENBERG, Louisville, KY (US)

(21) Appl. No.: 18/328,071

(22) Filed: Jun. 2, 2023

(51) Int. Cl. G06V 20/52; B64D 47/02; B64U 10/00; G05D 1/00; G06T 7/70; G06V 40/10; G08B 21/04

(52) U.S. Cl. CPC G06V 20/52; B64D 47/02; B64U 10/00; G06T 7/70; G06V 40/10; G08B 21/0476; B64U 2101/31; G06T 2207/10016; G06T 2207/10032; G06T 2207/30196

(57) ABSTRACT

A premises monitoring system is provided. The system includes a control device configured to communicate an unmanned aerial vehicle (UAV). The control device receives, from the UAV, a video depicting a person detected at the premises, the video having a duration, the duration having a pre-configured time period before a detection of the person and a pre-configured time period after the detection of the person. The control device determines, based on the video, a physical orientation of the person. The control device initiates an action based on the physical orientation of the person.

### TECHNICAL FIELD

The present technology is generally related to a premises monitoring system that determines when a person on the premises is in duress.

### BACKGROUND

Premises monitoring systems, such as security and automation systems may incorporate a range of “smart” devices and functionalities. For example, the systems may integrate various types of sensors to gather data about aspects of the premises. The devices may also include unmanned aerial vehicles (“UAVs”), also referred to as “drones,” which may be capable of recording video at the premises.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a diagram of an example system comprising a premises monitoring system according to embodiments of the present disclosure;

FIG. 2 is a block diagram of a control device according to some embodiments of the present disclosure;

FIG. 3 is a flowchart of an example process implemented by a control device according to some embodiments of the present disclosure; and

FIG. 4 is a diagram of an example patrol path according to some embodiments of the present disclosure.

### DETAILED DESCRIPTION

Embodiments of the present disclosure may leverage the use of premises devices, such as a UAV, to determine when a person on the premises is in duress. At least some embodiments described herein achieve this result by, for example, determining a physical orientation of the person's body, such as through the use of one or more cameras associated with one or more UAVs.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a,” “an” and “the” are intended to include the plural forms as well, unless the context clearly indicates otherwise. The terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. Multiple components may interoperate and modifications and variations are possible to achieve electrical and data communication.

In some embodiments described herein, the term “coupled,” “connected,” and the like, may be used herein to indicate a connection, although not necessarily directly, and may include wired and/or wireless connections.

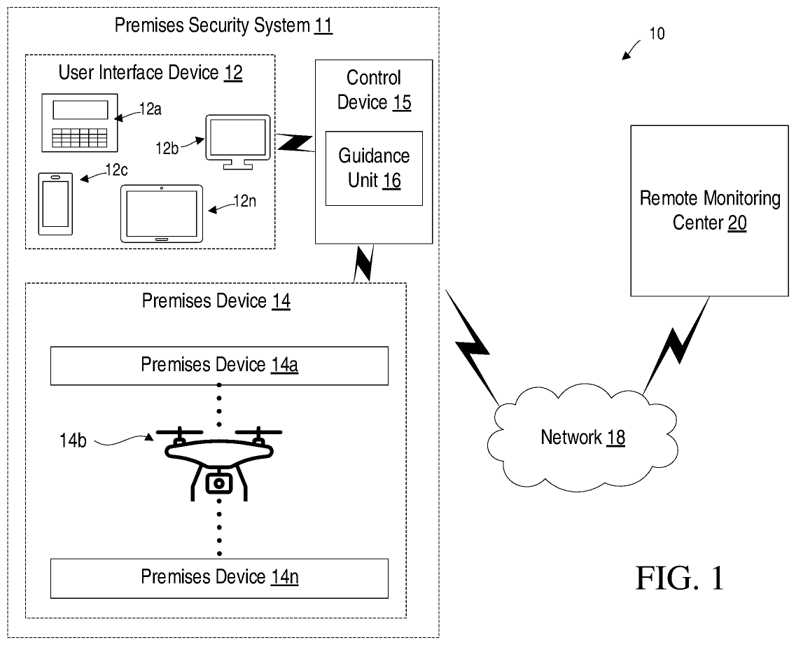

Referring now to the drawing figures in which like reference designators refer to like elements there is shown in FIG. 1 a system designated generally as “10.” System 10 may include premises monitoring system 11, in which premises monitoring system 11 includes and/or is associated with one or more user interface devices 12a to 12n (collectively referred to as “user interface device 12”), one or more premises devices 14a to 14n (collectively referred to as “premises devices 14”), and control device 15. According to various embodiments, the premises monitoring system 11 may be, for example, a premises security system and/or a premises automation system.

Premises devices 14 may include sensors, management panels, management apparatuses, images capture devices, life safety devices, premises automation devices, guidance devices, patrol devices, and/or other devices. For example, the types of sensors may include various life safety related sensors, such as motion sensors, fire sensors, carbon monoxide sensors, flooding sensors and contact sensors, among other sensor types. A management apparatus may include, for example, a device configured to adjust at least one premises setting, such as lighting, temperature, energy usage, door lock and power settings, among other settings associated with the premises or devices on the premises. Image capture devices may include digital cameras and/or video cameras, among other image capture devices. Patrol devices may include UAVs 14b and/or other flying and/or ground-based autonomous devices capable of moving about the premises, such as according to a patrol route.

System 10 may further include one or more networks 18, and one or more remote monitoring centers 20, communicating with each other or with at least one other entity in system 10.

User interface device 12 may be a wireless device that allows a user to communicate with control device 15. User interface device 12 may be a portable control keypad/interface 12a, computer 12b, mobile phone 12c or tablet 12n, among other devices that allow a user to interface with control device 15 and/or one or more premises devices 14. User interface device 12 may communicate at least with control device 15 using one or more wired and/or wireless communication protocols. For example, portable control keypad 12a may communicate with control device 15 via a ZigBee based communication link, e.g., network based on Institute of Electrical and Electronics Engineers (IEEE) 802.15.4 protocols, and/or Z-wave based communication link, or over the premises' local area network, e.g., network-based on Institute of Electrical and Electronics Engineers (IEEE) 802.11 protocols, user interface device 12. In one or more embodiments, user interface device 12a may be a control panel that performs one or more functions of control device 15.

The premises devices 14 may communicate with control device 15 via proprietary wireless communication protocols and may also use Wi-Fi. Other communication technologies can also be used, and the use of Wi-Fi is merely an example.

Control device 15 may provide one or more of management functions, monitoring functions, analysis functions, guidance functions, control functions such as power management, premises device management and alarm management and/or analysis, among other functions to premises monitoring system 11. In particular, control device 15 may manage one or more life safety or premises automation features. Life safety features may correspond to monitoring system functions and settings associated with premises conditions that may result in life threatening harm to a person, such as carbon monoxide detection and intrusion detection. Premises automation features may correspond to monitoring system functions and settings associated with video capturing devices and non-life-threatening conditions of the premises, such as lighting and thermostat functions. Control device 15 may also interact with and/or configure one or more premises devices 14 in the form of patrol devices, such as UAVs 14b or other flying or ground-based autonomous devices capable of moving about the premises, such as according to a patrol route.

Control device 15 may communicate with network 18 via one or more communication links. In particular, the communications links may be broadband communication links, such as a wired cable modem or Ethernet communication link, and a digital cellular communication link, such as a long term evolution (LTE) and/or 5G based link, among other broadband communication links. A broadband link in various embodiments may be a communication link other than a plain old telephone service (POTS) line. An Ethernet communication link may be an IEEE 802.3 or 802.11 based communication link. Network 18 may be a wide area network, local area network, wireless local network and metropolitan area network, among other networks. Network 18 provides communications among one or more of control device 15, remote monitoring center 20 and premises device 14. In at least one embodiment, the control device 15 and user interface device 12 are part of a single device such that the single device may perform the functions, described herein, of control device 15 and user interface device 12.

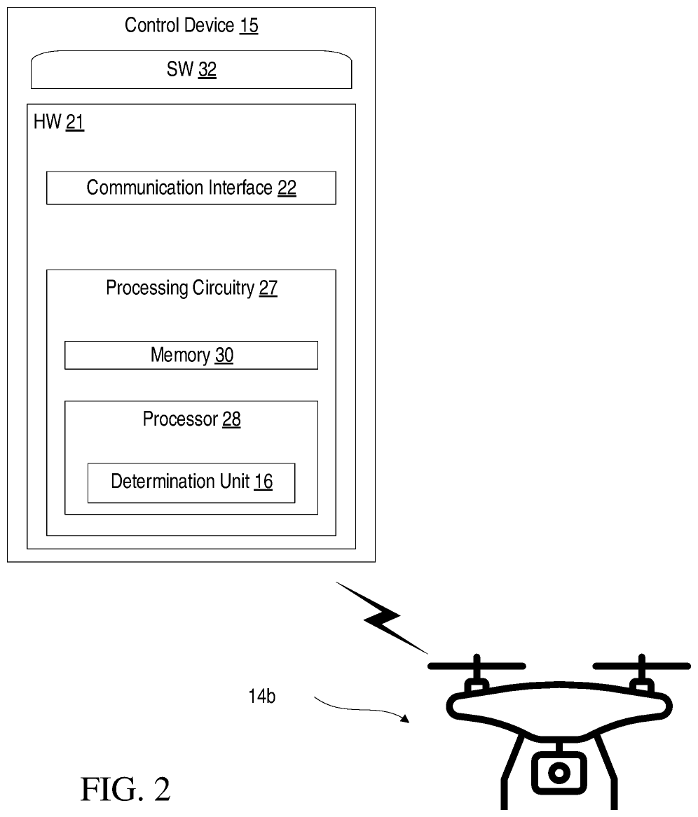

Referring now to FIG. 2, the example system 10 includes a control device 15 that includes hardware 21 enabling the control device 15 to communicate with one or more entities in system 10 and to perform one or more functions described herein. The depicted control device 15 is in communication with a premises device 14 in the form of a UAV 14b.

The hardware 21 may include a communication interface 22 for setting up and maintaining at least a wired and/or wireless connection to one or more entities in system 10, such as remote monitoring center 20, premises devices 14, user interface device 12, another control device 15, etc.

In the embodiment shown, the hardware 21 of the control device 15 further includes processing circuitry 27. The processing circuitry 27 may include a processor 28 and a memory 30. In particular, in addition to or instead of a processor, such as a central processing unit, and memory, the processing circuitry 27 may comprise integrated circuitry for processing and/or control, e.g., one or more processors, processor cores, field programmable gate arrays (FPGAs), and/or application specific integrated circuits (ASICs) adapted to execute instructions. The processor 28 may be configured to access (e.g., write to and/or read from) the memory 30, which may comprise any kind of volatile and/or nonvolatile memory, e.g., cache, buffer memory, random access memory (RAM), read-only memory (ROM), optical memory, and/or erasable programmable read-only memory (EPROM).

Thus, the control device 15 further has software 32 stored internally in, for example, memory 30, or stored in external memory (e.g., database, storage array, network storage device, etc.) accessible by the control device 15 via an external connection. The software 32 may be executable by the processing circuitry 27. The processing circuitry 27 may be configured to control any of the methods and/or processes described herein and/or to cause such methods, and/or processes to be performed, e.g., by control device 15. Processor 28 corresponds to one or more processors 28 for performing control device 15 functions described herein. The memory 30 is configured to store data, programmatic software code and/or other information described herein. In some embodiments, the software 32 may include instructions that, when executed by the processor 28 and/or processing circuitry 27, cause the processor 28 and/or processing circuitry 27 to perform the processes described herein with respect to control device 15. For example, processing circuitry 27 of the control device 15 may include determination unit 16, which is configured to perform one or functions described herein such as with respect to determining a physical orientation of a person at the premises.

Although FIGS. 1 and 2 show determination unit 16 as being within a respective processor, the determination unit 16 may be implemented such that a portion of the determination unit 16 is stored in a corresponding memory within the processing circuitry 27. In other words, determination unit 16 may be implemented in hardware or in a combination of hardware and software within the processing circuitry 27.

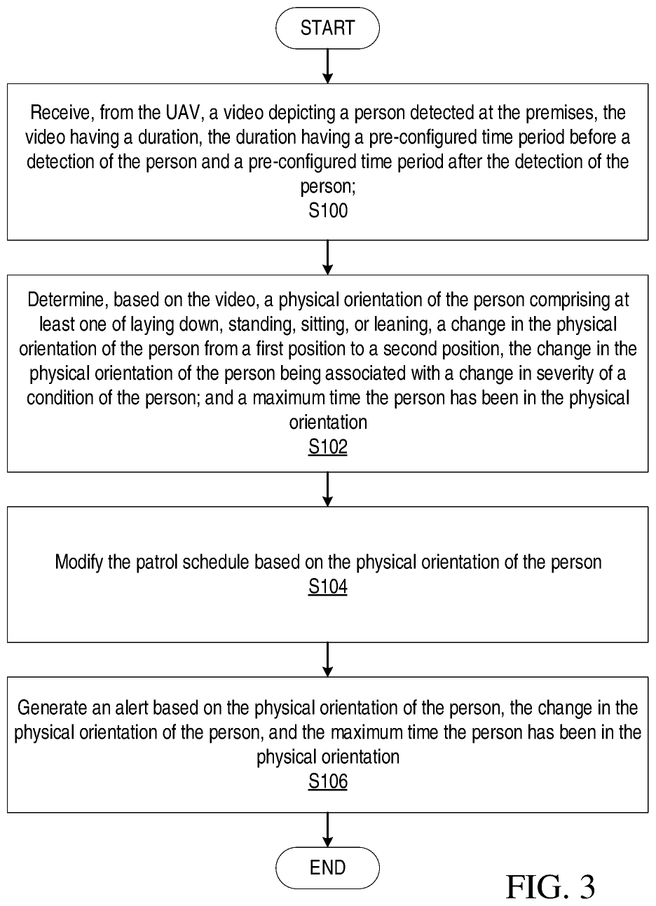

FIG. 3 is a flowchart of an example process implemented by a control device 15 according to one or more embodiments of the present disclosure. One or more blocks described herein may be performed by one or more elements of control device 15 such as by one or more of communication interface 22, processing circuitry 27 (including the determination unit 16) (including, for example, processor 28 that is caused to perform at least one action, step and/or process based on a plurality of instructions stored in memory 30), etc. Control device 15 is configured to receive, from the UAV 14b, a video depicting a person detected at the premises, the video having a duration, the duration comprising a pre-configured time period before a detection of the person 50 and a pre-configured time period after the detection of the person 50 (Block S100). Control device 15 is configured to determine, based on the video: a physical orientation of the person 50 comprising at least one of laying down, standing, sitting, or leaning, a change in the physical orientation of the person from a first position to a second position, the change in the physical orientation of the person being associated with a change in severity of a condition of the person; and a maximum time the person has been in the physical orientation (Block S102). Control device 15 is configured to modify the patrol schedule based on the physical orientation of the person (Block S104). Control device 15 is configured to generate an alert based on the physical orientation of the person, the change in the physical orientation of the person, and the maximum time the person has been in the physical orientation (Block S106).

In at least one embodiment, the physical orientation of the person 50 includes at least one of laying down, standing, sitting, or leaning.

In at least one embodiment, the control device 15 is configured to determine, based on the video, the physical orientation of the person 50 further by at least determining a change in the physical orientation of the person 50 from a first position to a second position.

In at least one embodiment, control device 15 is configured to determine the change in the physical orientation of the person 50 by determining a change in severity of a condition of the person 50 based at least on the change in the physical orientation from the first position to the second position.

In at least one embodiment, the UAV 14b is configured to patrol the premises 42 according to a patrol schedule; and the generation of the alert is further based on a determining of a maximum time the person 50 has been in the physical orientation.

In at least one embodiment, the control device 15 is configured to determine the maximum time the person 50 has been in the physical orientation based on: a last time the UAV 14b was at a location of the detection of the person 50; and a time of the detection of the person 50.

In at least one embodiment, the UAV 14b is configured to patrol the premises according to a patrol schedule; and the control device 15 is further configured to modify the patrol schedule based on the physical orientation of the person.

In at least one embodiment, the control device 15 is configured to modify the patrol schedule by at least causing the UAV 14b to at least one of maintain or move to a position proximate a location of the person 50.

In at least one embodiment, the generation of the alert comprises causing the UAV 14b to indicate the location of the person 50 by at least one of emitting a sound, emitting a light, or performing a movement.

Having described the general process flow of arrangements of the disclosure and having provided examples of hardware and software arrangements for implementing the processes and functions of the disclosure, the sections below provide details and examples of arrangements for guidance of an occupant through a premises. One or more control device 15 functions described below may be performed by one or more of processing circuitry 27, processor 28, determination unit 16, etc.

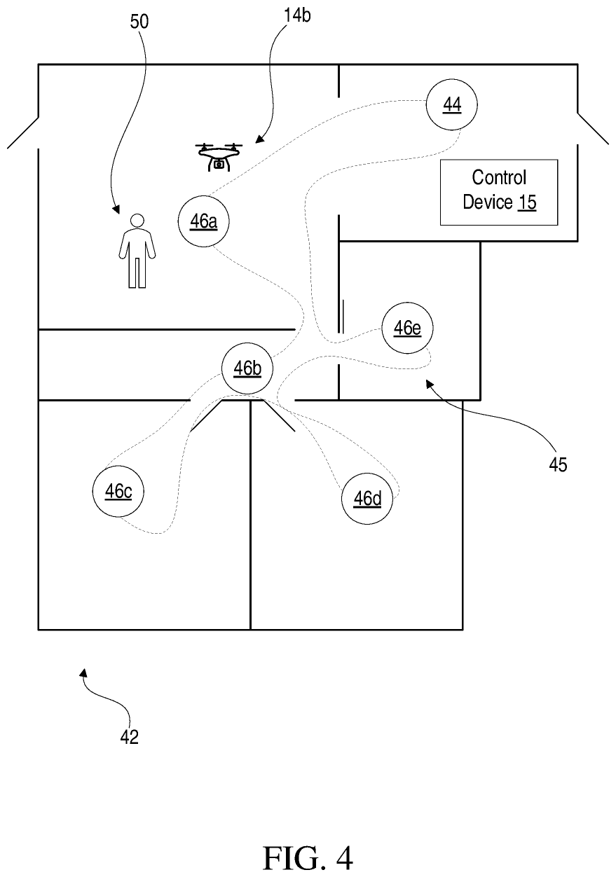

FIG. 4 depicts an example according to one or more embodiments of the present disclosure. As described herein, the control device 15 is located at the premises 42. The premises devices include a UAV 14b. The UAV 14b is configured, such as by the control device 15, to patrol the premises 42 according to one or more patrol routes 45. A patrol route 45 may be designated by, for example, one or more waypoints 46a-e arranged throughout the premises 42. In one or more embodiments, one waypoint may correspond to a base station 44, which may indicate the start and/or conclusion of a patrol route 45. The base station 44 may correspond to a charging station that allows the UAV to recharge, await further instructions from the control device 15, or otherwise communicate with the control device 15.

The UAV 14b is configured, such as by the control device 15, to detect the presence of a person 50 on the premises 42. Such detection may be achieved using one or more components of the UAV 14b including but not limited to a video camera.

After detection of the person 50 at the premises, the UAV 14b transmits a video to the control device 15. This may occur at the time of detection, or may occur once the UAV 14b returns to the base station 44 at the conclusion of the patrol route 45. The video corresponds to the detection of the person 50 and depicts at least the person 50. In at least one embodiment, the video has a duration that includes a pre-configured time period before detection of the person 50 and a configured time period after detection. For example, the video may have a 14-second duration that represents the seven seconds preceding detection and seven seconds following detection, i.e. both pre-configured time periods are seven seconds (though in various embodiments, the time periods may differ). This video may be excepted from a longer video the UAV 14b records as it conducts the patrol.

Detection of a person 50 triggers the control device 15 to perform video analytics on the received video to determine one or more physical orientations of the person 50. In at least one embodiment, this may be performed according to a machine learning model. According to various embodiments, the video analytics processing may be performed on one or more computing devices located on the premises and/or using one or more remote computing devices. Examples of physical orientation include whether the person is standing, sitting, leaning, laying down (including specifically whether face up, face down, or on a side). The physical orientation of the person 50 may correspond to an emergency medical condition. For example, the control device 15 may determine the person 50 is laying on the floor, which may correlate with the person 50 experiencing an emergency medical condition, such as cardiac arrest. In at least one embodiment, the control device 15 is configured to determine that the person 50 has changed position. This may be based on information, such as video, received from the UAV 14b while it observes the person 50, or may be determined based on video received from the UAV 14b as it conducts one or more successive patrols. The control device 15 may determine, based on the determination that the person 50 has changed position, that the change corresponds to a change in severity of the person's 50 condition. For example, a person may change position from sitting to laying, which may be correlated with a medical condition worsening.

Based on the physical orientation of the person 50, the control device 15 generates an alert. Various embodiments may generate this alert based on determination of one or more different physical orientations, and/or of a determined change in severity, depending on configuration of the control device 15. For example, some embodiments may generate the alert based on determining that the person 50 is sitting, other embodiments may generate the alert based on determining the person 50 is laying down. In at least one embodiment, generating the alert includes causing transmission of a message to an operator associated with the premises monitoring system 11 and/or remote monitoring center 20. In at least one embodiment, an alert may be generated by a premises device 14, such as a speaker or light. In at least one embodiment, the UAV 14b indicates the location of the person 50. Non-limiting examples of indications include emitting a sound (which may include, e.g., any of a beep, chime, siren, pre-recorded message, or computer-generated message), emitting a light, and performing a movement, such as moving in a pattern (such as up and down). As a result, the indication may draw attention to the person 50, allowing others at the premises (including emergency personnel) to quickly locate the person 50 and assist.

In at least one embodiment, the control device 15 configures the UAV 14b to patrol the premises 42 according to a predefined patrol schedule. Based on the patrol schedule and the time the person 50 is detected, the control device 15 may determine a maximum time the person was in the physical orientation. For example, if the person is determined to be in the physical orientation as of time t, and the UAV 14b was last in an area 46a where the person 50 was detected at time t-u, then u represents the maximum amount of time the person may have been in the physical orientation. This information may allow emergency personnel to prepare treatment based on the longest period of time that the person 50 has been in the physical orientation.

In at least one embodiment, the control device 15 may modify the patrol route 45 to cause the UAV 14b to deviate from the configured patrol route 45 upon determination that the physical orientation meets certain criteria as described herein. The modified patrol route may cause the UAV 14b to hold a position in an area 46a near the person 50, such as to facilitate emergency personnel and/or an operator monitoring the person 50 or guiding the emergency personnel and/or operator to the area 46a. In at least one embodiment, the control device 15 may cause the UAV 14b to return to the base station 44.

In at least one embodiment, the UAV 14b is configured to patrol according to a predefined schedule, and modifying the patrol route 45 may include modifying the schedule. Examples of schedule modifications include increasing or decreasing how often the UAV 14b follows the patrol route 45, increasing or decreasing the speed at which the UAV 14b moves along the patrol route 45, one or more of modifying, adjusting, adding and deleting at least one waypoint 46 such as to modify the patrol route 45. In at least one embodiment, increasing the frequency and speed of the UAV 40's patrol route 45 may allow for more frequent opportunities to observe the person 50 and determine any change in the person 50's physical orientation.

While only one UAV 14b is illustrated in FIG. 4, the teachings described herein are equally applicable to premises 42 being monitored by a plurality of UAVs 14b that may be configured with one or more respective patrol routes 45, where the determinations described herein may be based on video captured by one or more of the plurality of UAVs 14b, and functions described herein may be applicable to one or more of the plurality of UAVs 14b.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects, which may generally be referred to herein as a “unit.” Any process, step, action and/or functionality described herein may be performed by, and/or associated to, a corresponding unit, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, it should be noted that all of the accompanying drawings are not to scale. A variety of modifications and variations are possible in light of the above teachings without departing from the scope and spirit of the present disclosure.

What is claimed is:

1. A premises monitoring system for monitoring a premises, the premises monitoring system comprising:
an unmanned aerial vehicle (UAV) configured to patrol the premises according to a patrol schedule;
a control device in communication with the UAV, the control device comprising:
at least one processor; and
at least one memory storing a plurality of instructions that, when executed by the at least one processor, cause the control device to:
receive, from the UAV, a video depicting a person detected at the premises, the video having a duration, the duration having a pre-configured time period before a detection of the person and a pre-configured time period after the detection of the person;
determine, based on the video:
a physical orientation of the person, the physical orientation comprising at least one of laying down, standing, sitting, or leaning;
a change in the physical orientation of the person from a first position to a second position, the change in the physical orientation of the person being associated with a change in severity of a condition of the person; and
a maximum time the person has been in the physical orientation;
modify the patrol schedule based on the physical orientation of the person; and
generate an alert based on the physical orientation of the person, the change in the physical orientation of the person, and the maximum time the person has been in the physical orientation.

2. The premises monitoring system of claim 1, wherein the plurality of instructions, when executed by the processor, further cause the control device to modify the patrol schedule by at least causing the UAV to at least one of maintain or move to a position proximate a location of the person.

3. A premises monitoring system for monitoring a premises, the premises monitoring system comprising:
a control device configured to communicate with an unmanned aerial vehicle (UAV), the control device comprising:
at least one processor; and
at least one memory storing a plurality of instructions that, when executed by the at least one processor, cause the control device to:
receive, from the UAV, a video depicting a person detected at the premises, the video having a duration, the duration comprising a pre-configured time period before a detection of the person and a pre-configured time period after the detection of the person;
determine, based on the received video, a physical orientation of the person; and
initiate an action based on the physical orientation of the person.

4. The premises monitoring system of claim 3, wherein the physical orientation of the person comprises at least one of laying down, standing, sitting, or leaning.

5. The premises monitoring system of claim 3, wherein the plurality of instructions, when executed by the at least one processor, further cause the control device to determine, based on the video, the physical orientation of the person by at least determining a change in the physical orientation of the person from a first position to a second position.

6. The premises monitoring system of claim 5, wherein the plurality of instructions, when executed by the at least one processor, further cause the control device to determine the change in the physical orientation of the person by determining a change in severity of a condition of the person based at least on the change in the physical orientation from the first position to the second position.

7. The premises monitoring system of claim 3, wherein:
the UAV is configured to patrol the premises according to a patrol schedule; and
the action comprises generating an alert based on determining a maximum time the person has been in the physical orientation.

8. The premises monitoring system of claim 7, wherein the plurality of instructions, when executed by the at least one processor, further cause the control device to determine the maximum time the person has been in the physical orientation based on:
a last time the UAV was at a location of the detection of the person; and
a time of the detection of the person.

9. The premises monitoring system of claim 3, wherein:
the UAV is configured to patrol the premises according to a patrol schedule; and
the plurality of instructions, when executed by the processor, further cause the control device to modify the patrol schedule based on the physical orientation of the person.

10. The premises monitoring system of claim 9, wherein the plurality of instructions, when executed by the at least one processor, further cause the control device to modify the patrol schedule by causing the UAV to at least one of maintain or move to a position proximate a location of the person.

11. The premises monitoring system of claim 3, wherein the action comprises causing the UAV to indicate a location of the person by at least one of emitting a sound, emitting a light, or performing a movement.

12. A method implemented by a control device of a premises monitoring system located at a premises, the method comprising:
receiving, from a UAV located at the premises, a video depicting a person detected at the premises, the video having a duration, the duration comprising a pre-configured time period before a detection of the person and a pre-configured time period after the detection of the person;
determining, based on the video, a physical orientation of the person; and
initiate an action based on the physical orientation of the person.

13. The method of claim 12, wherein the physical orientation of the person comprises at least one of laying down standing, sitting, or leaning.

14. The method of claim 12, wherein the determining, based on the video, the physical orientation of the person further comprises determining a change in the physical orientation of the person from a first position to a second position.

15. The method of claim 14, wherein determining the change in the physical orientation of the person further comprises determining a change in severity of a condition of the person based on the change in the physical orientation from the first position to the second position.

16. The method of claim 12, wherein:
the UAV is configured to patrol the premises according to a patrol schedule; and
the action comprises generating an alert based on determining a maximum time the person has been in the physical orientation.

17. The method of claim 16, wherein determining the maximum time the person has been in the physical orientation is further based on:
a last time the UAV was at a location of the detection of the person; and
a time of the detection of the person.

18. The method of claim 12, wherein:
the UAV is configured to patrol the premises according to a patrol schedule; and
the method further comprises modifying the patrol schedule based on the physical orientation of the person.

19. The method of claim 18, wherein modifying the patrol schedule comprises causing the UAV to at least one of maintain or move to a position proximate a location of the person.

20. The method of claim 12, wherein the action comprises causing the UAV to indicate a location of the person by at least one of emitting a sound, emitting a light, or performing a movement.
